(19) United States
(12) Patent Application Publication
(10) Pub. No.: US 2014/0366680 A1
(43) Pub. Date: Dec. 18, 2014

(54) BICYCLE HANDLEBAR ASSEMBLY AND METHOD

(71) Applicant: Thomas J. Schwoegler, Naperville, IL (US)

(72) Inventor: Thomas J. Schwoegler, Naperville, IL (US)

(21) Appl. No.: 13/920,659

(22) Filed: Jun. 18, 2013

(51) Int. Cl. B62K 21/26

(52) U.S. Cl. CPC B62K 21/26
USPC 74/551.9; 29/447

(57) ABSTRACT

A method for securing handlebar tape to a bicycle handlebar is provided comprising wrapping a length of handlebar tape along a length of handlebar; positioning a length of a heat-shrinkable sleeve so that it overlaps the terminal end of the handlebar tape; and heating the sleeve so that it substantially uniformly contracts to secure the terminal end of the handlebar tape to the handlebar. A handlebar assembly for a bicycle is also provided comprising a handlebar; handlebar tape covering a selected length of the handlebar; and a heat shrinkable sleeve overlapping the terminal end of the handlebar tape to secure the end of the handlebar tape to the handlebar.

### FIELD OF THE DISCLOSURE

The present application relates to a bicycle handlebar assembly and method, and, more particularly to an assembly and method in which tape is secured to the handlebars.

### BACKGROUND

Bicycle handlebar tape provides a comfortable, protective and aesthetic interface between the bicycle handlebar and the rider's hands. It is typically applied starting from the end of the handlebar, with a plug received in the end of the handlebar securing the starting end in place, and wrapping the handlebar tape in a circular pattern towards the center of the handlebar, terminating short of the handlebar stem. When the process is completed, the free end of the handlebar tape must be secured to the bar to prevent it from unwrapping.

Most handlebar tape manufacturers provide a 6 to 8 inch piece of plastic adhesive tape to keep the free end in place. The supplied adhesive tape is commonly supplemented or replaced with electrical or some other flexible, water resistant adhesive tape. The amount of the alternative adhesive tape used, can exceed 15 to 20 inches.

The tape typically used to secure the end of the handlebar tape to the handlebars has a tendency to deteriorate significantly with normal use. The adhesive breaks down and the tape either unwinds, or the adhesive makes both the handlebar tape and the handlebar sticky. Thus, an improved method of securing the end of the handlebar tape to the handlebars is needed.

### SUMMARY

In a first aspect of the disclosure, a method for securing handlebar tape to a bicycle handlebar is provided comprising wrapping a length of handlebar tape along a length of handlebar; positioning a length of a heat-shrinkable sleeve so that it overlaps a terminal end of the handlebar tape; and heating the sleeve so that it substantially uniformly contracts to secure the terminal end of the handlebar tape to the handlebar.

In a related aspect, the handlebar tape is wrapped around the handlebar such that an exposed portion of the handlebar extends beyond the terminal end of the handlebar tape. The length of heat shrinkable sleeve is then positioned so that it overlaps both the exposed portion of the handlebar and the terminal end of the handlebar tape, and heating the sleeve substantially uniformly contracts the sleeve to secure the terminal end of the handlebar tape to the exposed portion of the handlebar.

In another aspect, the sleeve is heated with hot air. Preferably, a heat gun is used for heating the sleeve.

In a further aspect, the terminal end of the handlebar is secured in position to the handlebar prior to heating the sleeve. Preferably, adhesive tape is used to secure the terminal end of the handlebar tape to the handlebar prior to heating the sleeve.

In another aspect, the sleeve comprises flexible polyolefin tubing. Preferably, the sleeve, before heating, has a diameter of approximately 1.5 in., and a length of from 2 in. to 6 in.

In a second aspect of the disclosure, a handlebar assembly for a bicycle is provided comprising a handlebar; handlebar tape covering a selected length of the handlebar; and a heat shrinkable sleeve overlapping the terminal end of the handlebar tape to secure the end of the handlebar tape to the handlebar.

In a related aspect, an exposed portion of the handlebar extends beyond a terminal end of the handlebar tape, and the heat shrinkable sleeve overlaps the exposed portion of the handlebar and the terminal end of the handlebar tape to secure the end of the handlebar tape to the handlebar.

### BRIEF DESCRIPTION OF THE FIGURES

FIG. 1 is a top view of a handlebar assembly according to the present disclosure.

### DETAILED DESCRIPTION OF THE EMBODIMENTS

A more detailed description of the handlebar assembly and method in accordance with the present disclosure is set forth below. It should be understood that description below of specific devices and methods is intended to be exemplary, and not exhaustive of all possible variations or applications. Thus, the scope of the disclosure is not intended to be limiting, and should be understood to encompass variations or embodiments that would occur to persons of ordinary skill.

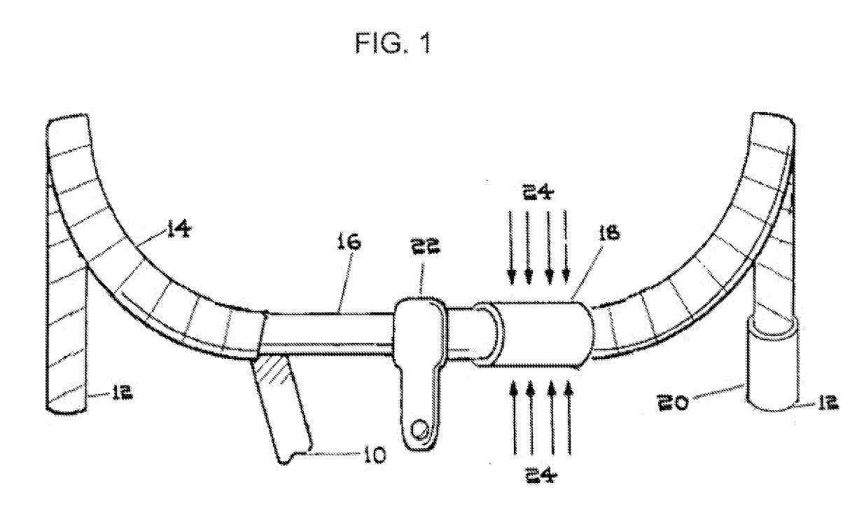

By way of the present disclosure, and with reference to FIG. 1, an improved method of securing a terminal end 10 or 12 of handlebar tape 14 to a handlebar 16 is provided in which the adhesive-based tape or bar end plug is replaced with a thermo-elastic or heat-shrink sleeve 18 or 20. The sleeve is positioned to overlap the terminal end of the handlebar tape (sleeve 18 overlapping end 10 and sleeve 20 overlapping end 12), and is then heat is applied as indicated by arrows 24, allowing the sleeve to contract uniformly. The contraction secures the tape 14 to the handlebar 16, conforming to the shape of both the tape and the handlebar. The bond formed by the shrinkage of the sleeve upon the application of heat eliminates the need for adhesive tape, and provides a secure, durable and aesthetic attachment.

The method may be used to secure either end of the handlebar tape to the handlebar, i.e., the end 12 of the handlebar tape that corresponds with the end of the handlebar (where the tape wrapping starts), or the end 10 of the handlebar tape adjacent the handlebar stem 22 (where the tape wrapping ends). If securing the end 10 of the handlebar tape near the stem 22, the sleeve 18 is positioned to overlap both the terminal end of the handlebar tape and an exposed portion of the handlebar. If securing the end 12 of the handlebar tape at the handlebar end 12, the sleeve 20 is positioned so that, upon shrinkage, the end of the sleeve corresponds with the end of the handlebar.

More particularly, prior to applying the handlebar tape, a length of heat-shrink tubing (such as FP-301 flexible polyolefin tubing manufactured by 3M) is positioned on the handlebar where the handlebar tape will terminate. The pre-shrunk length of the tubing segment is preferably between 2 to 6 inches. As can be appreciated, the pre-shrunk diameter of the tubing must be greater than the largest diameter of the handlebars. A pre-shrunk diameter of 1.5 inches is satisfactory for most applications.

When the handlebar wrapping process is complete, the end of the tape may be secured in place by, e.g., a small piece of adhesive tape or the like, while the heat-shrink tubing is positioned so that it is properly positioned over the terminal end 10 or 12 of the wrapped handlebar tape. Heat is then applied to the tubing by, e.g., a hand-held heat gun or the like. The 3M FP-301 tubing referred to above has a 2:1 shrink ratio, and will conform to the texture of both the tape and the handlebar when heat is applied. When cooled to ambient temperature, the tubing retains its position and smooth outer texture. The tubing also retains a small amount of flexibility, thus complementing the function of the tape to provide a more comfortable riding experience and aesthetic appearance. Additionally, the tubing can also be applied to the handlebar ends where the tape wrapping starts to provide additional strength.

Thus an improved handlebar assembly and method of securing handlebar tape to a handlebar have been provided. It will be understood that the embodiments described above are illustrative of some of the applications of the principles of the present subject matter, and that numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A method for securing handlebar tape to a bicycle handlebar comprising:
wrapping a length of handlebar tape along a length of handlebar;
positioning a length of a heat-shrinkable sleeve so that it overlaps a terminal end of the handlebar tape; and
heating the sleeve so that it substantially uniformly contracts to secure the terminal end of the handlebar tape to the handlebar.

2. The method of claim 1 wherein an exposed portion of the handlebar extends beyond the terminal end of the handlebar tape; the length of heat shrinkable sleeve is positioned so that it overlaps both the exposed portion of the handlebar and the terminal end of the handlebar tape; and heating the sleeve substantially uniformly contracts the sleeve to secure the terminal end of the handlebar tape to the exposed portion of the handlebar.

3. The method of claim 1 wherein the sleeve is heated with hot air.

4. The method of claim 2 wherein a heat gun is used for heating the sleeve.

5. The method of claim 1 wherein the terminal end of the handlebar is secured in position to the handlebar prior to heating the sleeve.

6. The method of claim 5 wherein adhesive tape is used to secure the terminal end of the handlebar tape to the handlebar prior to heating the sleeve.

7. The method of claim 1 wherein the sleeve comprises flexible polyolefin tubing.

8. The method of claim 7 wherein the sleeve, before heating, has a diameter of approximately 1.5 in., and a length of from 2 in. to 6 in.

9. A handlebar assembly for a bicycle comprising:
a handlebar;
handlebar tape covering a selected length of the handlebar; and
a heat shrinkable sleeve overlapping the terminal end of the handlebar tape to secure the end of the handlebar tape to the handlebar.

10. The handlebar assembly of claim 9 wherein an exposed portion of the handlebar extends beyond a terminal end of the handlebar tape, and the heat shrinkable sleeve overlaps the exposed portion of the handlebar and the terminal end of the handlebar tape to secure the end of the handlebar tape to the handlebar.

11. The handlebar assembly of claim 8 wherein the sleeve comprises flexible polyolefin tubing.

12. The method of claim 2 wherein the sleeve is heated with hot air.

13. The method of claim 2 wherein the terminal end of the handlebar is secured in position to the handlebar prior to heating the sleeve.

14. The method of claim 3 wherein the terminal end of the handlebar is secured in position to the handlebar prior to heating the sleeve.

15. The method of claim 4 wherein the terminal end of the handlebar is secured in position to the handlebar prior to heating the sleeve.

16. The method of claim 2 wherein the sleeve comprises flexible polyolefin tubing.

17. The method of claim 3 wherein the sleeve comprises flexible polyolefin tubing.

18. The method of claim 4 wherein the sleeve comprises flexible polyolefin tubing.

19. The method of claim 5 wherein the sleeve comprises flexible polyolefin tubing.

20. The method of claim 6 wherein the sleeve comprises flexible polyolefin tubing.
